(19) United States
(12) Patent Application Publication
(10) Pub. No.: US 2026/0367929 A1
(43) Pub. Date: Nov. 19, 2026

(54) DEVICE STATE-ADAPTIVE APPLICATION EXPERIENCE

(71) Applicant: Airbnb, Inc., San Francisco, CA (US)

(72) Inventors: Pranay Airan, Union City, CA (US); Aditya Punjani, Mountain View, CA (US); Denis Litvin, Seattle, WA (US); Matthew Yun, San Francisco, CA (US); Ryan T. Holmes, Berkeley, CA (US)

(21) Appl. No.: 19/208,290

(22) Filed: May 14, 2025

(51) Int. Cl. G06F 9/445; G06F 11/30

(52) U.S. Cl. CPC G06F 9/44505; G06F 11/3055; G06F 2201/81

(57) ABSTRACT

An embodiment includes detecting a static device state and a dynamic device state of a device. An embodiment includes generating, from the static device state and the dynamic device state of the device, using a machine learning model trained to generate an application action preference from a device state, a first application action preference corresponding to the static device state and the dynamic device state. An embodiment includes adjusting, according to the first application action preference, a behavior of an asset management application executing on the device.

### TECHNICAL FIELD

The present disclosure generally relates to a user experience of a software application, and more particularly to a device state-adaptive application experience.

### BACKGROUND

An asset management platform facilitates management of assets such as properties, typically providing options for advertising an asset's availability, searching for an asset based on one or more criteria, generating or viewing an asset description, reserving an asset for use, paying for an asset's use, and managing an existing reservation. One non-limiting example of an asset management platform is a property reservation platform managing listing options for guests to reserve and pay for stays at one or more properties, such as hotel rooms, apartments, or houses. A property reservation platform typically includes an ability to search for a property based on one or more criteria, generate or view a property description (optionally including a map, image of the property, video, or reviews from previous guests), reserve and pay for a stay at a property, and manage an existing reservation as a guest or host. The platform is typically implemented on a server and users access the platform via a website or application executing on a client device.

### SUMMARY

Some embodiments of the present disclosure provide a computer-implemented method for device state-adaptive application experience. The method includes detecting a static device state and a dynamic device state of a device; generating, from the static device state and the dynamic device state of the device, using a machine learning model trained to generate an application action preference from a device state, a first application action preference corresponding to the static device state and the dynamic device state; and adjusting, according to the first application action preference, an action of an asset management application executing on the mobile device.

Some embodiments of the present disclosure provide a non-transitory computer-readable medium storing a program for device state-adaptive application experience. The program, when executed by a computer, configures the computer to detect a static device state and a dynamic device state of a device; generate, from the static device state and the dynamic device state of the device, using a machine learning model trained to generate an application action preference from a device state, a first application action preference corresponding to the static device state and the dynamic device state; and adjust, according to the first application action preference, an action of an asset management application executing on the mobile device.

Some embodiments of the present disclosure provide a system for device state-adaptive application experience. The system comprises a processor and a non-transitory computer readable medium storing a set of instructions, which when executed by the processor, configure the processor to detect a static device state and a dynamic device state of a device; generate, from the static device state and the dynamic device state of the device, using a machine learning model trained to generate an application action preference from a device state, a first application action preference corresponding to the static device state and the dynamic device state; and adjust, according to the first application action preference, an action of an asset management application executing on the mobile device.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement device state-adaptive application experience, according to some embodiments.

FIG. 2 is a block diagram illustrating details of a system for device state-adaptive application experience, according to some embodiments.

FIG. 3 depicts a block diagram of an example configuration for device state-adaptive application experience, in accordance with an illustrative embodiment.

FIG. 4 depicts an example of device state-adaptive application experience, in accordance with an illustrative embodiment.

FIG. 5 depicts another example of device state-adaptive application experience, in accordance with an illustrative embodiment.

FIG. 6 depicts a flowchart of an example process for device state-adaptive application experience. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

One asset management application (i.e., an application users use to access an asset management platform) implements a user experience on a baseline device under baseline conditions and then on improving the user experience on devices with limited hardware capabilities or devices that were under stress conditions. For example, on a baseline device, images of an asset such as a property might be displayed at a baseline size (e.g., 30 kilobytes) while on a device with a slower processor, smaller screen, or using a slower network than the baseline images might be displayed at a smaller size (e.g., 7 kilobytes), thus enabling as good a user experience as possible given a particular device and its operating conditions. There is a desire to enhance the application user experience, for example adding additional interactivity, motion, and including as high-quality media as can be supported on a particular device. However, enhancing the application user experience for a more capable device should not degrade the application user experience on a less capable device. Thus, the illustrative embodiments recognize that there is a need to create adaptive experiences that cater to different device capabilities, hardware and network conditions, by implementing an improved experience on devices with best-in-class network and hardware capabilities without penalizing performance for less capable devices.

Embodiments of the present disclosure address the above identified problems by implementing device state-adaptive application experience. In particular, an embodiment detects a static device state and a dynamic device state of a device; generates, from the static device state and the dynamic device state of the device, using a machine learning model trained to generate an application action preference from a device state, a first application action preference corresponding to the static device state and the dynamic device state; and adjusts, according to the first application action preference, an action of an asset management application executing on the device.

An embodiment uses a presently available technique to detect a static device state and a dynamic device state of a device on which an asset management application is executing. A device on which an asset management application is executing is often, but need not be limited to, a mobile device. A static device state does not change while the asset management application is executing. A static device state includes one or more static signals, for example the number of processor cores in the device, the model of device this is, the processor speed of each processor core, the type of device, the operating system executing on the device, and the screen resolution of the device, and the like. A dynamic device state can change while the asset management application is executing. A dynamic device state includes one or more dynamic signals, for example the amount of memory available on a device, whether or not the device is in a low memory state (i.e., available memory is below a threshold amount or percentage of the total memory on the device), a device's battery charge percentage (if the device is battery powered), whether or not a battery saver mode of the device is enabled, whether or not a data saver mode (to reduce data communication over a network) is enabled, a device's temperature, a device's thermal condition (e.g., whether or not the device is above a threshold temperature), whether or not the device has a metered network connection, the type of network connection the device has available, the speed of network connection the device has available, and the like.

From a static device state and a dynamic device state of a device on which an asset management application is executing, an embodiment generates an application action preference corresponding to the static device state and the dynamic device state. To generate an application action preference, one embodiment uses a decision tree, and another embodiment uses a set of heuristics or rules, both presently available techniques. To generate an application action preference, other embodiments use a machine learning model trained to generate an application action preference from one or more signals in a device state. In one embodiment, the trained machine learning model executes on the device on which the asset management application is executing. In another embodiment, the device on which the asset management application is executing is unable to execute the trained machine learning model (e.g., because executing the trained machine learning model requires a higher-speed processor or more memory than available), and thus the device on which the asset management application is executing sends a static device state and a dynamic device state to a remote device that executes the trained machine learning model and sends a result back to the originating device.

An embodiment adjusts an action or behavior of an asset management application according to the application action preference. In some embodiments, the application action preference includes a network usage preference and adjusting the behavior of the asset management application includes adjusting a rate at which the asset management application requests or sends data over a network or whether network data is requested or sent at all. In one embodiment, network usage preference has three possible values: Enhanced, Standard, and Reduced. In one embodiment, the default value is Standard. For example, logging and benchmarking are not core behavior of an asset management application and hence might be deferred, reduced, or eliminated altogether if the network usage preference is set to Reduced (e.g., because the asset management application is executing on a device with a comparatively slow network connection or a metered network connection). As another example, if the network usage preference is set to Enhanced, the asset management application might speculatively prefetch data before a user requests the data, speeding up and hence improving the user's experience when supportable. Other network usage preference values and corresponding application actions and behaviors are also possible and contemplated within the scope of the illustrative embodiments.

In some embodiments, the application action preference includes a storage usage preference and adjusting the behavior of the asset management application includes adjusting an amount of local caching the asset management application performs. In one embodiment, storage usage preference has three possible values: Enhanced, Standard, and Reduced. In one embodiment, the default value is Standard. For example, an asset management application might cache images and data (e.g., for use on a home screen of the application or as part of a user's search or chat history). If the storage usage preference is set to Reduced, the application might perform less or no caching, saving storage for another use, but if the storage usage preference is set to Enhanced, the asset management application might cache more, including the results of prefetching data, speeding up and hence improving the user's experience when supportable. Other storage usage preference values and corresponding application actions and behaviors are also possible and contemplated within the scope of the illustrative embodiments.

In some embodiments, the application action preference includes a media usage preference and adjusting the action of the asset management application includes adjusting a rendering quality of media (e.g., a still image or video) the asset management application renders. In one embodiment, media usage preference has three possible values: Enhanced, Standard, and Reduced. In one embodiment, the default value is Standard. Adjusting a media usage preference setting adjusts, for example, image quality, image size, and bit rate for video. One embodiment adjusts media rendering quality locally, i.e., on the device on which the asset management application is executing. For example, the asset management application might subsample a standard-size image to render the image at reduced quality or interpolate additional pixels into the image to render the image at enhanced quality. Another embodiment uses a media usage preference setting to request media with a particular quality level from a content delivery network, and the content delivery network supplies the requested media at the desired rendering quality. For example, an asset management application might request reduced, standard, or enhanced quality images or video and display what the content delivery network provides. Other media usage preference values and corresponding application actions and behaviors are also possible and contemplated within the scope of the illustrative embodiments.

In some embodiments, the application action preference includes a motion usage preference and adjusting the behavior of the asset management application includes adjusting an amount of animation performed by the asset management application. In one embodiment, motion usage preference has three possible values: Enhanced, Standard, and Reduced. In one embodiment, the default value is Standard. For example, an asset management application might use an animation to transition between views of an asset such as a property. If the motion usage preference is set to Reduced, the application might skip the animation, but if the storage usage preference is set to Enhanced, the asset management application might perform a more elaborate animation. Other motion usage preference values and corresponding application actions and behaviors are also possible and contemplated within the scope of the illustrative embodiments.

In some embodiments, an application action preference is sticky, i.e., once assigned it remains at the same setting for an entire application session. In some embodiments, an application action preference is live, i.e., changeable when an embodiment detects that a dynamic device state has changed by more than a threshold amount or percentage, or an output of a trained machine learning model receiving the dynamic device state as input changes to another preference setting. For example, a battery status of a device might have moved into a Low category (thus necessitating a change to a Reduced setting in several preferences), or the device might have moved from an area with poor cellular data reception into an area with excellent cellular data reception (thus an opportunity to update the network usage preference to an Enhanced setting).

In some embodiments, adjusting an action or behavior of the asset management application includes notifying a user that application behavior is being adjusted from baseline behavior. In some embodiments, adjusting an action or behavior of the asset management application includes notifying a user when application behavior is being enhanced from baseline behavior. In some embodiments, a user is able to disable application action adjustment altogether or disable application enhancement from baseline behavior.

In some embodiments, adjusting an action or behavior of the asset management application includes adjusting how many options are displayed in search results, when using the asset management application to search for a property to reserve. For example, if one or more of the media usage preference, motion usage preference, storage usage preference, and network usage preferences is set to the Enhanced setting, the device is likely to support downloading and displaying data for more properties than if one or more preferences are set to the Reduced setting.

In some embodiments and conforming with local laws and regulations, adjusting an action or behavior of the asset management application includes adjusting how search results are ranked for display in the asset management application. For example, if a user sufficiently consistently executes the asset management application on a slower-than-average device with a poorer-than-average network connection and a smaller-than-average screen, an embodiment might adjust the behavior of the asset management application to rank search results by their affordability (e.g., ranking apartments higher than very large houses) or suggest less expensive destinations for the user. In some embodiments, as static device signals can be indicative of a device the user owns, adjusting how search results are ranked for display in the asset management application is performed using one or more static device signals and not dynamic device signals. In embodiments, a user is able to disable search result ranking based on device characteristics.

Some embodiments generate an application action preference based on another signal or factor. One embodiment retrains a trained machine learning model to generate an application usage preference based on how an application usage preference affects changes in reservations or other user behavior. For example, if playing an animation results in an increase in abandoned attempts to reserve a property, an embodiment might retrain a trained machine learning model to set a motion usage preference to Reduced for all users, regardless of their device's capabilities. Another embodiment retrains a trained machine learning model to generate a network usage preference based on the device's location in network terms (e.g., how close the device is to a network gateway, thus how much latency is expected when transmitting data to or from the device). Another embodiment retrains a trained machine learning model to generate a network usage preference based on a combination of the device's location in network terms and the device's physical location. For example, if application data indicates that devices in a particular geographic area typically have a poor network connection, an embodiment might adjust a trained machine learning model to generate a network usage preference set to Reduced for a device in that geographic area, regardless of the actual network conditions the device is experiencing. Other model adjustments and application usage preferences are also possible and contemplated within the scope of the illustrative embodiments.

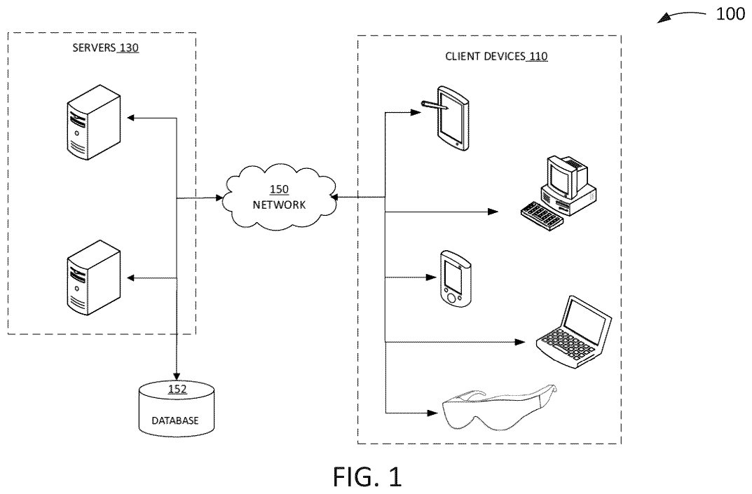

FIG. 1 illustrates a network architecture 100 used to implement device state-adaptive application experience, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

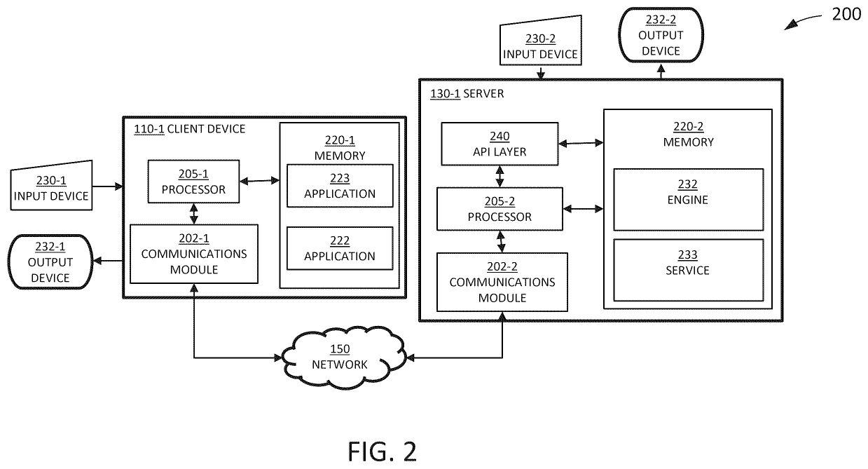

FIG. 2 is a block diagram illustrating details of a system 200 for device state-adaptive application experience, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement device state-adaptive application experience. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide device state-adaptive application experience. The application 223 may communicate with service 233 through API layer 240, for example.

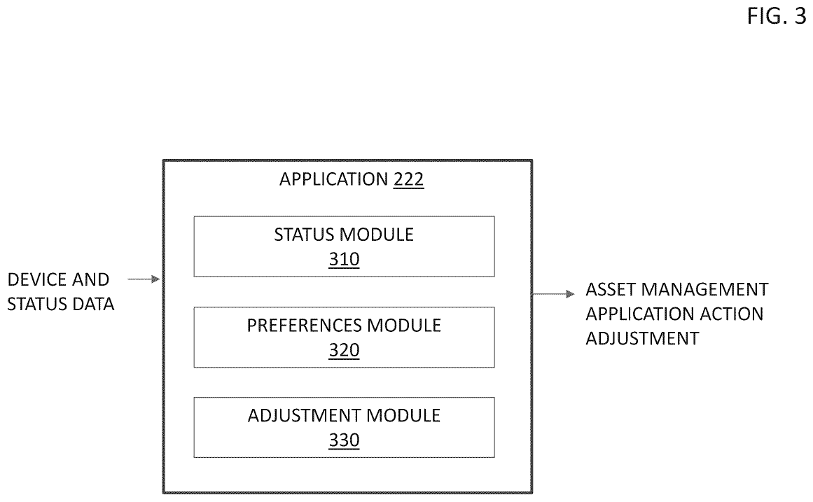

FIG. 3 depicts a block diagram of an example configuration for device state-adaptive application experience, in accordance with an illustrative embodiment. Application 222 is the same as application 222 in FIG. 2.

Status module 310 uses a presently available technique to detect a static device state and a dynamic device state of a device on which an asset management application is executing. A device on which an asset management application is executing is often, but need not be limited to, a mobile device. A static device state does not change while the asset management application is executing. A static device state includes one or more static signals, for example the number of processor cores in the device, the model of device this is, the processor speed of each processor core, the type of device, the operating system executing on the device, and the screen resolution of the device, and the like. A dynamic device state can change while the asset management application is executing. A dynamic device state includes one or more dynamic signals, for example the amount of memory available on a device, whether or not the device is in a low memory state (i.e., available memory is below a threshold amount or percentage of the total memory on the device), a device's battery charge percentage (if the device is battery powered), whether or not a battery saver mode of the device is enabled, whether or not a data saver mode (to reduce data communication over a network) is enabled, a device's temperature, a device's thermal condition (e.g., whether or not the device is above a threshold temperature), whether or not the device has a metered network connection, the type of network connection the device has available, the speed of network connection the device has available, and the like.

From a static device state and a dynamic device state of a device on which an asset management application is executing, preferences module 320 generates an application action preference corresponding to the static device state and the dynamic device state. To generate an application action preference, one implementation of module 310 uses a decision tree, and another implementation of module 310 uses a set of heuristics or rules, both presently available techniques. To generate an application action preference, other implementations of module 310 use a machine learning model trained to generate an application action preference from one or more signals in a device state. In one implementation of module 310, the trained machine learning model executes on the device on which the asset management application is executing. In another implementation of module 310, the device on which the asset management application is executing is unable to execute the trained machine learning model (e.g., because executing the trained machine learning model requires a higher-speed processor or more memory than available), and thus the device on which the asset management application is executing sends a static device state and a dynamic device state to a remote device that executes the trained machine learning model and sends a result back to the originating device.

Adjustment module 330 adjusts an action or behavior of an asset management application according to the application action preference. In some implementations of module 330, the application action preference includes a network usage preference and adjusting the action of the asset management application includes adjusting a rate at which the property application requests or sends data over a network or whether network data is requested or sent at all. In one implementation of module 330, network usage preference has three possible values: Enhanced, Standard, and Reduced. In one implementation of module 330, the default value is Standard. For example, logging and benchmarking are not core behavior of an asset management application and hence might be deferred, reduced, or eliminated altogether if the network usage preference is set to Reduced (e.g., because the asset management application is executing on a device with a comparatively slow network connection or a metered network connection). As another example, if the network usage preference is set to Enhanced, the asset management application might speculatively prefetch data before a user requests the data, speeding up and hence improving the user's experience when supportable. Other network usage preference values and corresponding application actions and behaviors are also possible.

In some implementations of module 330, the application action preference includes a storage usage preference and adjusting the action of the asset management application includes adjusting an amount of local caching the asset management application performs. In one implementation of module 330, storage usage preference has three possible values: Enhanced, Standard, and Reduced. In one implementation of module 330, the default value is Standard. For example, an asset management application might cache images and data (e.g., for use on a home screen of the application or as part of a user's search or chat history). If the storage usage preference is set to Reduced, the application might perform less or no caching, saving storage for another use, but if the storage usage preference is set to Enhanced, the asset management application might cache more, including the results of prefetching data, speeding up and hence improving the user's experience when supportable. Other storage usage preference values and corresponding application actions and behaviors are also possible.

In some implementations of module 330, the application action preference includes a media usage preference and adjusting an action or behavior of the asset management application includes adjusting a rendering quality of media (e.g., a still image or video) the asset management application renders. In one implementation of module 330, media usage preference has three possible values: Enhanced, Standard, and Reduced. In one implementation of module 330, the default value is Standard. Adjusting a media usage preference setting adjusts, for example, image quality, image size, and bit rate for video. One implementation of module 330 adjusts media rendering quality locally, i.e., on the device on which the asset management application is executing. For example, the asset management application might subsample a standard-size image to render the image at reduced quality or interpolate additional pixels into the image to render the image at enhanced quality. Another implementation of module 330 uses a media usage preference setting to request media with a particular quality level from a content delivery network, and the content delivery network supplies the requested media at the desired rendering quality. For example, an asset management application might request reduced, standard, or enhanced quality images or video and display what the content delivery network provides. Other media usage preference values and corresponding application actions and behaviors are also possible.

In some implementations of module 330, the application action preference includes a motion usage preference and adjusting an action or behavior of the asset management application includes adjusting an amount of animation performed by the asset management application. In one implementation of module 330, motion usage preference has three possible values: Enhanced, Standard, and Reduced. In one implementation of module 330, the default value is Standard. For example, an asset management application might use an animation to transition between views of a property. If the motion usage preference is set to Reduced, the application might skip the animation, but if the storage usage preference is set to Enhanced, the asset management application might perform a more elaborate animation. Other motion usage preference values and corresponding application actions and behaviors are also possible.

In some implementations of module 330, an application action preference is sticky, i.e., once assigned it remains at the same setting for an entire application session. In some implementations of module 330, an application action preference is live, i.e., changeable when application 222 detects that a dynamic device state has changed by more than a threshold amount or percentage, or an output of a trained machine learning model receiving the dynamic device state as input changes to another preference setting. For example, a battery status of a device might have moved into a Low category (thus necessitating a change to a Reduced setting in several preferences), or the device might have moved from an area with poor cellular data reception into an area with excellent cellular data reception (thus an opportunity to update the network usage preference to an Enhanced setting).

In some implementations of module 330, adjusting an action or behavior of the asset management application includes notifying a user that application behavior is being adjusted from baseline behavior. In some implementations of module 330, adjusting the behavior of the asset management application includes notifying a user when application behavior is being enhanced from baseline behavior. In some implementations of module 330, a user is able to disable application action adjustment altogether or disable application enhancement from baseline behavior.

In some implementations of module 330, adjusting an action or behavior of the asset management application includes adjusting how many options are displayed in search results, when using the asset management application to search for a property to reserve. For example, if one or more of the media usage preference, motion usage preference, storage usage preference, and network usage preferences is set to the Enhanced setting, the device is likely to support downloading and displaying data for more properties than if one or more preferences are set to the Reduced setting.

In some implementations of module 330 and conforming with local laws and regulations, adjusting an action or behavior of the asset management application includes adjusting how search results are ranked for display in the asset management application. For example, if a user sufficiently consistently executes the asset management application on a slower-than-average device with a poorer-than-average network connection and a smaller-than-average screen, module 330 might adjust the behavior of the asset management application to rank search results by their affordability (e.g., ranking apartments higher than very large houses) or suggest less expensive destinations for the user. In some implementations of module 330, as static device signals can be indicative of a device the user owns, adjusting how search results are ranked for display in the asset management application is performed using one or more static device signals and not dynamic device signals. In implementations of module 330, a user is able to disable search result ranking based on device characteristics.

Some implementations of application 222 generate an application action or behavior preference based on another signal or factor. One implementation of application 222 retrains a trained machine learning model to generate an application usage preference based on how an application usage preference affects changes in property reservations or other user behavior. For example, if playing an animation results in an increase in abandoned attempts to reserve a property, application 222 might retrain a trained machine learning model to set a motion usage preference to Reduced for all users, regardless of their device's capabilities. Another implementation of application 222 retrains a trained machine learning model to generate a network usage preference based on the device's location in network terms (e.g., how close the device is to a network gateway, thus how much latency is expected when transmitting data to or from the device). Another implementation of application 222 retrains a trained machine learning model to generate a network usage preference based on a combination of the device's location in network terms and the device's physical location. For example, if application data indicates that devices in a particular geographic area typically have a poor network connection, application 222 might adjust a trained machine learning model to generate a network usage preference set to Reduced for a device in that geographic area, regardless of the actual network conditions the device is experiencing. Other model adjustments and application usage preferences are also possible.

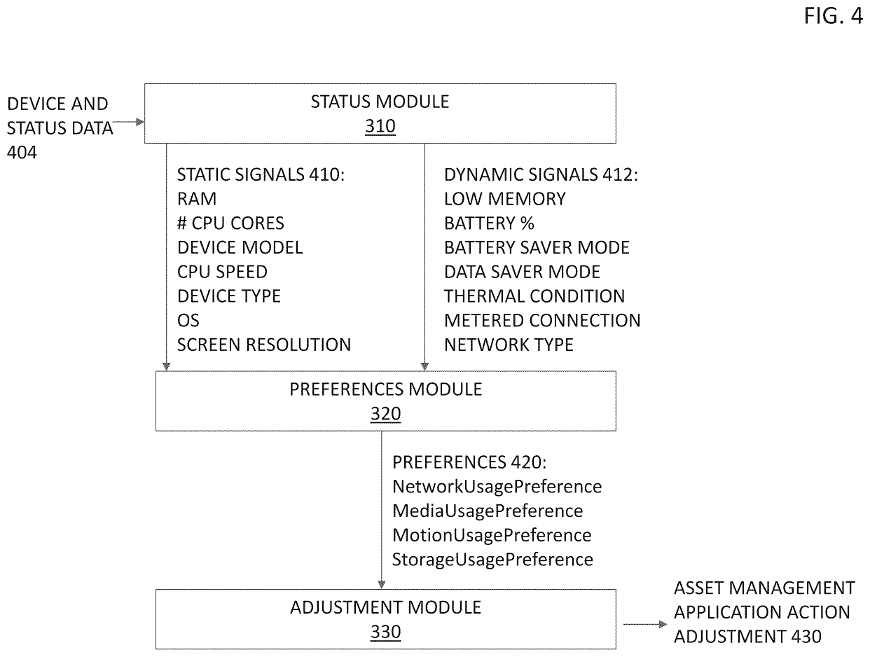

FIG. 4 depicts an example of device state-adaptive application experience, in accordance with an illustrative embodiment. The example can be executed using application 222 in FIG. 2. Status module 310, preferences module 320, and adjustment module 330 are the same as status module 310, preferences module 320, and adjustment module 330 in FIG. 3.

Status module 310 receives device and status data 404 and uses a presently available technique to determine static signals 410 and dynamic signals 412 of a device on which an asset management application is executing. From static signals 410 and dynamic signals 412, preferences module 320 generates preferences 420, an application action preference. As an example, preferences 420 includes values for the NetworkUsagePreference, MediaUsagePreference, MotionUsagePreference, and StorageUsagePreference variables. Adjustment module 330 adjusts an action or behavior of an asset management application according to preferences 420, outputting asset management application action adjustment 430.

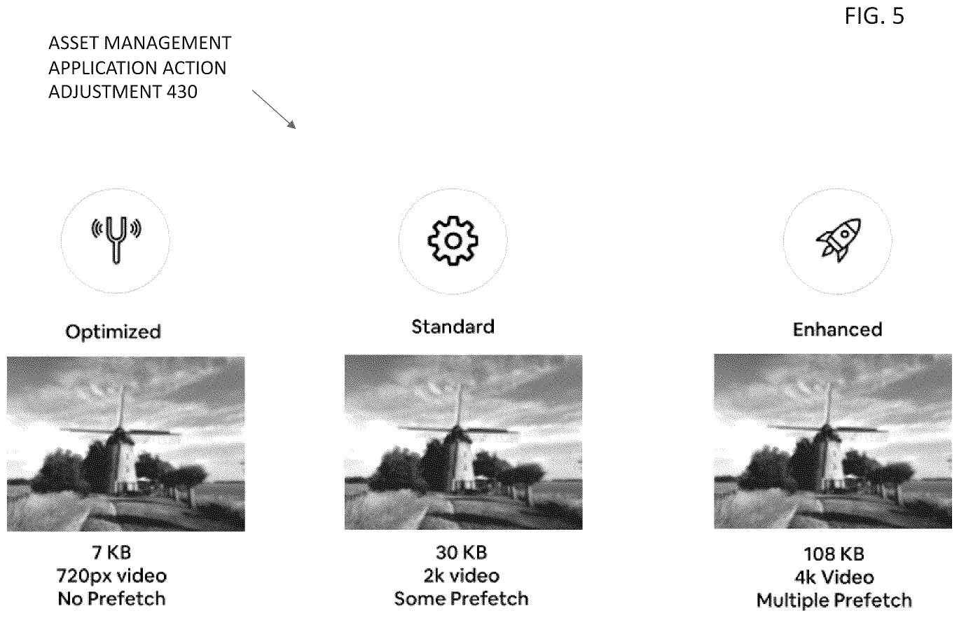

FIG. 5 depicts another example of device state-adaptive application experience, in accordance with an illustrative embodiment. The example can be executed using application 222 in FIG. 2. Asset management application action adjustment 430 is the same as asset management application action adjustment 430 in FIG. 4

In particular, FIG. 5 depicts examples of asset management application action adjustment 430: a standard user experience, an optimized application user experience for less capable devices and situations, and an enhanced application user experience for more capable devices and situations.

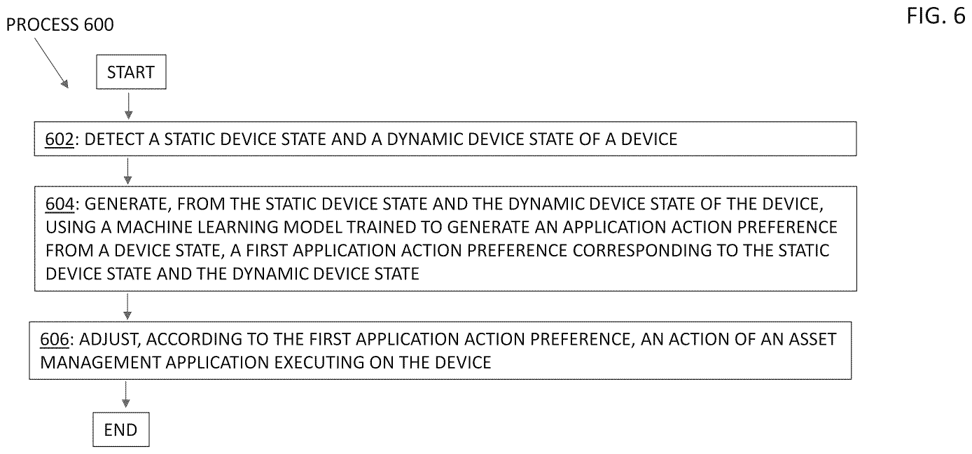

FIG. 6 depicts a flowchart of an example process for device state-adaptive application experience, in accordance with an illustrative embodiment. Process 600 can be implemented in application 222 in FIG. 2.

At block 602, the process detects a static device state and a dynamic device state of a device. At block 604, the process generates, from the static device state and the dynamic device state of the device, using a machine learning model trained to generate an application action preference from a device state, a first application action preference corresponding to the static device state and the dynamic device state. At block 606, the process adjusts, according to the first application action preference, an action of an asset management application executing on the device. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
detecting a static device state and a dynamic device state of a device;
generating, from the static device state and the dynamic device state of the device, using a machine learning model trained to generate an application behavior preference from a device state, a first application action preference corresponding to the static device state and the dynamic device state; and
adjusting, according to the first application action preference, an action of an asset management application executing on the device.

2. The computer-implemented method of claim 1, wherein the machine learning model executes on the device.

3. The computer-implemented method of claim 1, wherein generating, using the machine learning model, the first application action preference comprises:
sending, to a remote device hosting the machine learning model, the static device state and the dynamic device state of the device; and
receiving, from the remote device in responsive to the sending, the first application action preference generated by the machine learning model.

4. The computer-implemented method of claim 1, wherein the first application action preference comprises a network usage preference and adjusting the action of the asset management application comprises adjusting a network data usage of the asset management application.

5. The computer-implemented method of claim 1, wherein the first application action preference comprises a storage usage preference and adjusting the action of the asset management application comprises adjusting an amount of local caching of the asset management application.

6. The computer-implemented method of claim 1, wherein the first application action preference comprises a media usage preference and adjusting the action of the asset management application comprises adjusting a rendering quality of an image rendered by the asset management application.

7. The computer-implemented method of claim 1, wherein the first application action preference comprises a motion usage preference and adjusting the action of the asset management application comprises adjusting an amount of animation performed by the asset management application.

8. The computer-implemented method of claim 1, further comprising:
detecting, on the device, that the dynamic device state has changed by more than a threshold amount;
generating, responsive to detecting that the dynamic device state has changed by more than the threshold amount, using the machine learning model, a second application action preference corresponding to the static device state and the changed dynamic device state; and
adjusting, according to the second application action preference, the action of the asset management application.

9. A non-transitory computer-readable medium storing a program, which when executed by a computer, configures the computer to:
detect a static device state and a dynamic device state of a device;
generate, from the static device state and the dynamic device state of the device, using a machine learning model trained to generate an application action preference from a device state, a first application action preference corresponding to the static device state and the dynamic device state; and
adjust, according to the first application action preference, an action of an asset management application executing on the device.

10. The non-transitory computer-readable medium of claim 9, wherein the machine learning model executes on the device.

11. The non-transitory computer-readable medium of claim 9, wherein the program to generate, using the machine learning model, the first application action preference, when executed by the computer, further configures the computer to:
send, to a remote device hosting the machine learning model, the static device state and the dynamic device state of the device; and
receive, from the remote device in responsive to the sending, the first application action preference generated by the machine learning model.

12. The non-transitory computer-readable medium of claim 9, wherein the first application action preference comprises a network usage preference and adjusting the action of the asset management application comprises adjusting a network data usage of the asset management application.

13. The non-transitory computer-readable medium of claim 9, wherein the first application action preference comprises a storage usage preference and adjusting the action of the asset management application comprises adjusting an amount of local caching of the asset management application.

14. The non-transitory computer-readable medium of claim 9, wherein the first application action preference comprises a media usage preference and adjusting the action of the asset management application comprises adjusting a rendering quality of an image rendered by the asset management application.

15. The non-transitory computer-readable medium of claim 9, wherein the first application action preference comprises a motion usage preference and adjusting the action of the asset management application comprises adjusting an amount of animation performed by the asset management application.

16. The non-transitory computer-readable medium of claim 9, wherein the program, when executed by the computer, further configures the computer to:
detect, on the device, that the dynamic device state has changed by more than a threshold amount;
generate, responsive to detecting that the dynamic device state has changed by more than the threshold amount, using the machine learning model, a second application action preference corresponding to the static device state and the changed dynamic device state; and
adjust, according to the second application action preference, the action of the asset management application.

17. A system comprising:
a processor; and
a non-transitory computer readable medium storing a set of instructions, which when executed by the processor, configure the system to:
detect a static device state and a dynamic device state of a device;
generate, from the static device state and the dynamic device state of the device, using a machine learning model trained to generate an application action preference from a device state, a first application action preference corresponding to the static device state and the dynamic device state; and
adjust, according to the first application action preference, an action of an asset management application executing on the device.

18. The system of claim 17, wherein the machine learning model executes on the device.

19. The system of claim 17, wherein the instructions, when executed by the processor, further configure the system to:
send, to a remote device hosting the machine learning model, the static device state and the dynamic device state of the device; and
receive, from the remote device in responsive to the sending, the first application action preference generated by the machine learning model.

20. The system of claim 17, wherein the first application action preference comprises a network usage preference and adjusting the action of the asset management application comprises adjusting a network data usage of the asset management application.
